(19) United States
(12) Patent Application Publication
(10) Pub. No.: US 2007/0067756 A1
(43) Pub. Date: Mar. 22, 2007

(54) System and method for enterprise software portfolio modernization

(75) Inventor: David M. Garza, San Antonio, TX (US)

Correspondence Address: Andrew G. DiNovo;JENKENS & GILCHRIST, A PROFESSIONAL CORPORATION, 1445 Ross Avenue, Suite 3200, Dallas, TX, 75202, US

(73) Assignee: Trinity Millennium Group, Inc.

(21) Appl. No.: 11/231,004

(22) Filed: Sep. 20, 2005

(51) Int. Cl. G06F 9/45

(52) U.S. Cl. 717/136

(57) ABSTRACT

A system and method are disclosed for analyzing and converting legacy software systems. The system and method of the invention involves a multi-task process including preparing an overview characterization of the software application; parsing the source code of said software application; generating business process models; identifying business rules from said business process models; generating a plurality of UML models; identifying a set of modernization requirements; performing a gap analysis; and converting said legacy software application into a target application meeting said set of modernization requirements.

### FIELD OF THE INVENTION

The present invention relates generally to the field of computer software, and more particularly to a system and method for enterprise portfolio modernization by analyzing and converting legacy software systems.

### BACKGROUND OF THE INVENTION

As computer technology has evolved over the last few decades, businesses have acquired various computer hardware and software to enhance productivity and streamline business processes. Because functional components have often been acquired piecemeal, however, there have arisen numerous compatibility and interoperability problems, as well as difficulties in asset management. As a consequence, it is sometimes desirable to analyze existing software assets, referred to herein as “legacy applications,” in a thorough manner to identify the company's existing software holdings. Moreover, it may be desirable to convert legacy applications into one or more new languages or platforms to enhance interoperability, asset management and the like.

The importance of legacy applications to the success of a business, however, is often critical. Since businesses often depend on the stability and power of legacy/enterprise applications, downtime must be minimized and sometimes may not be tolerated. By adopting a systematic approach to analysis and conversion, it is possible to increase the likelihood of a successful project while decreasing the impact of the transition on business processes and eliminate “code freezes” and “vendor-lock”.

Accordingly, what is needed is a system and method for analyzing and converting legacy software systems in a comprehensive, rigorous and efficient fashion, such as an incremental approach to analysis and conversion of legacy software systems, in accordance with embodiments of the present invention.

### SUMMARY OF THE INVENTION

A system and method for enterprise portfolio modernization is disclosed herein. The system and method comprises eight tasks with six embedded automated technology tools to perform specific steps within each task. By employing embodiments of the system and method disclosed herein, a user can efficiently and thoroughly analyze and convert legacy software systems so that existing assets can be inventoried, assessments can be made about future acquisitions and business processes streamlined.

A preferred embodiment on the present invention may comprise some or all of the following tasks:
Task 1: Generation of a baseline repository and “characterization” of the legacy application
Task 2: Source code Parsing of the languages
Task 3: Automatic flowcharting of all programs
   3a. Business logic filtering, matching, intelligence refinement, naming conventions, grouping and definition specifications, harvesting of the relevant components and artifacts.
   3b. Function Point Analysis
Task 4: Business rule harvesting (capturing and extraction of business rule candidates buried in the legacy application code);
Task 5: Exportation of relevant information from the legacy application system and importing into several of the Unified Modeling Language models such as Class, Object, Component and Activity diagrams via UML modeling program, and presentation of information in browser-type format;
Task 6: Knowledge engineering/requirements analysis;
Task 7: Development of transformation plans; and
Task 8: Forward engineering/transformation to target system.

Further understanding of various embodiments of the present invention will be better understood in connection with the description of preferred embodiments below, and by reference to the claims.

### BRIEF DESCRIPTION OF THE DRAWINGS

The foregoing and other advantages of the invention will become apparent upon reading the following detailed description and upon reference to the drawings, wherein:

FIG. 1 illustrates an enterprise portfolio modernization meta-model in accordance with the present invention;

FIG. 2 illustrates the portfolio modernization process in flowchart format;

FIG. 3 continues an exemplary flowchart of the portfolio modernization process of FIG. 2;

FIG. 4 is a table providing exemplary languages and database schemas for legacy applications that may be converted;

FIG. 5 illustrates an exemplary flowchart diagram of the type that might result in connection with performance of task 3;

FIG. 6 illustrates an exemplary application process flowchart of the type that might result in connection with performance of task 3;

FIG. 7 illustrates a screen view including a sample of a rules set;

FIG. 8 illustrates a screen view including a sample of the error detection;

FIG. 9 illustrates a screen view including a sample of the error explanation; and

FIG. 10 illustrates an exemplary static structure UML diagram from the legacy applications data structures.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF A PREFERRED EMBODIMENT

The present invention relates to analysis and conversion of legacy applications in a methodical, incremental and efficient manner.

The tasks relating to this system and method are described below. While they are described as eight distinct tasks, a person of ordinary skill in the art will understand that they might be combined into grouping or separated into additional steps within these tasks, while remaining true to the spirit and letter of the invention.

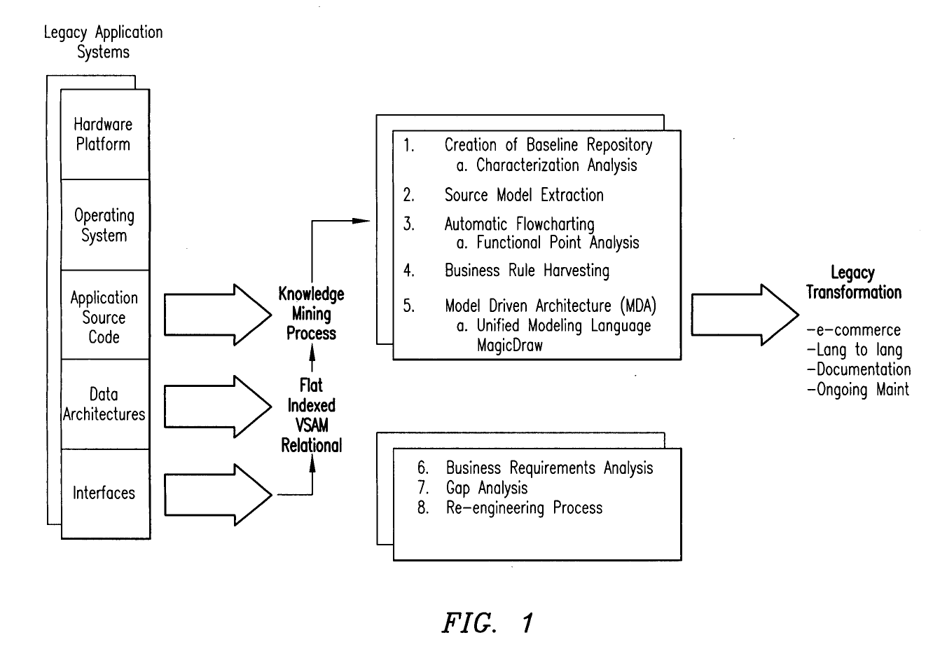

FIG. 1 provides a meta-model for the system and method disclosed herein. It identifies eight tasks to be performed when converting a legacy system to a target system.

In certain instances, identification of the mainframe may facilitate later language identification. The analyst, for example, may identify IBM390, which would result in excluding NET applications, which do not run on that mainframe.

In reference to FIG. 1, task 1 provides an overview and characterization of the legacy/enterprise application system to be knowledge-mined. This task provides an overview of the character of the legacy application to be knowledge mined. Software Psychology shows that every application contains a particular “culture” within it and the Task of Characterizing an application extrapolates that ‘culture’. Assuming that the present invention is implemented by a third party practitioner on behalf of a business with legacy applications, then in order for the practitioner of the present invention to provide the business with an accurate cost estimate to knowledge mine the whole enterprise of applications in its entirety, it is necessary to perform an initial analytical characterization of the application.

In the first part of task 1, the platform of the operating system and hardware platform are identified. Then the computer language for each program must be identified.

One mechanism for doing this is determining the existence of a filing extension, which may be verified in subsequent steps. An alternative method is analyzing syntax of the program. This method of identification differentiates this embodiment of the present invention from most prior art systems, which do not accomplish language identification. The operator may identify multiple languages to consider when evaluating code to identify the source language. This set may include, e.g., all languages that may be run in the operating system/hardware configuration of the system at issue. Boxes can be highlighted to show languages that were detected during catalogue, as a consequence of the file extension.

Based upon what is checked, a distinct module for each language can be run for the various files to catalogue the syntax and determine if the language comports to that module. Test requirements are established based upon features unique to that language. In some situations, test requirements may be manually adjusted based upon unusual or proprietary usage within an organization's computer systems.

If the tool cannot identify the language, analysts may review the code to determine why the tool did not identify the code as corresponding to standard syntax.

The main technology engine in the system and process is the TMGi-SAT tool. This tool encompasses a set of syntax rules to aid in the identification of over 100 source code languages automatically. Components and symantec checks are made against is source code module/program that is unique to that source code language. When dealing with mainframe languages the files will typically not contain file extensions that easily identify a language therefore, the TMGi-SAT engine automates this step in the process.

Source code cleanup may be undertaken at this time to clean up, which may entail replacement unrecognized characters, such as those outside the ASCII table, with placeholders.

Following the baseline repository, missing modules (e.g., those that are called by other programs and not included within the code under test) are identified and, if obtained, included in the repository for reprocessing. Those that cannot be obtained reported as desired.

Characterization of the repository entails reporting regarding the code identifying a number of items. This characterization task may provide some or all of the following elements of information:
a. Architecture and technology (alignment with strategy);
b. Extensibility (bigness);
c. Number of calls/performs/gotos;
d. Complexity and organization of code (standard and non-standardization);
e. Documentation (e.g. data dictionary);
f. Understanding of business rules;
g. Functionality (meet customer's needs);
h. Number and complexity of interfaces;
i. Organization of databases;
j. Organization of tables;
k. Flexibility of adding new data elements to code block;
l. Generation of program maps; and
m. Total application statistics.

Again in reference to FIG. 1, task 2 is the source code parsing process. When modernizing legacy applications, it is useful to know the architecture in which the application resides, how an application works and why it was written. In this step, the extraction tool “tears down,” parses, extrapolates and re-arranges all the detailed information necessary in order to reconstruct the application in a way that shows how the enterprise application works and why it was written in the first place. For example, where programs call subprograms or modules, those modules are inserted into a new file for each file.

All source code is parsed down to its lowest level, thereby extracting information that is used to analyze the architecture and process flow of the logic. Tables, records and fields are analyzed in each language identified in the baseline repository step. Related variables are identified, captured and tabulated. All data may be stored into a database, such as a relational database having relational tables, such as that provided by SQL.

Certain categories of data that may be collected may include variables, system overhead, data I/O functions, code block returns, work area variables, functions, algorithms, calls and performs, relationships, data attributes and program Is mapping.

Task 3 comprises the automatic flowcharting of all programs and generation of business process models. Every program can be automatically and individually flowcharted using data input to a charting application (e.g., Visio) to capture the following characteristics:
a. Complexity;
b. Logic Flow;
c. Maintainability;
d. Input; and
e. Output.

These criteria will allow the knowledge mining process, described infra, to capture all algorithms embedded within the legacy application code. These flowchart models can then fed into an automated process that generates business process flows of the total legacy application system.

The results of task 3 also allow the practitioner of the present invention to produce Function Point Analysis (FPA) reports customized to the target systems. Some objectives of FPA are:
Measuring functionality that the user requests and receives; and
Measuring software development and maintenance independently of technology used for implementation.
Some benefits of FPA are measurements that determine:
the size of an application by counting all of the functions;
the benefit of an application to their organization or to validate how far separated an application is from existing business processes;
the units of software product to support quality and productivity analysis;
the estimated cost and resources required for software development and maintenance; and
the normalization factor for software comparison between applications.

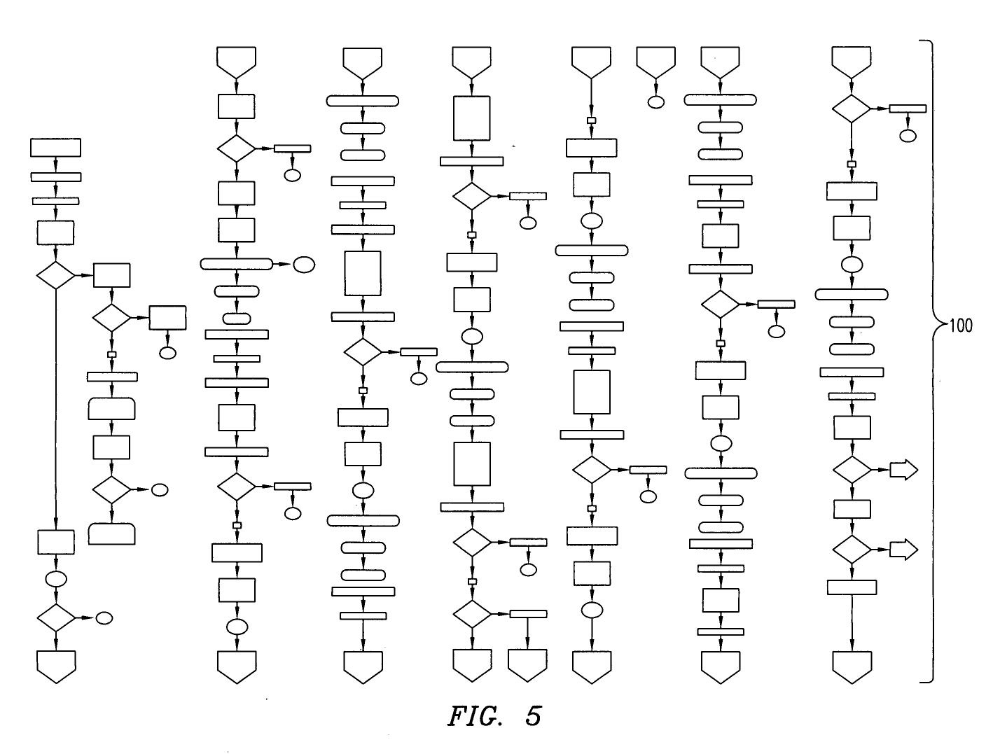

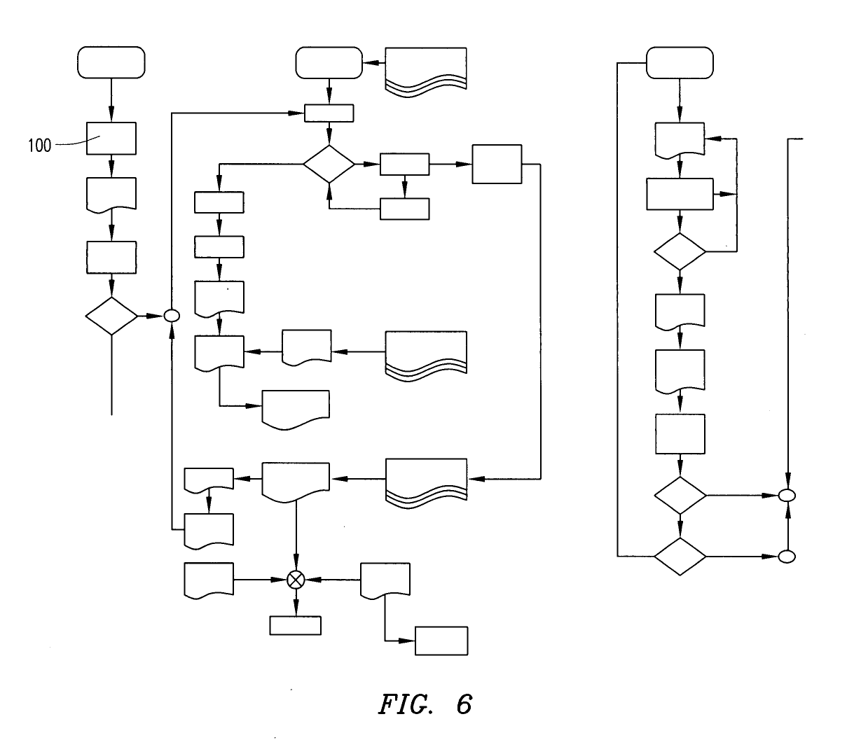

Program flowchart diagrams and/or application process flowcharts are shown in FIG. 5 and FIG. 6, respectively. Symbol 100 in FIG. 6 corresponds to the entirety of the program flowchart diagram shown in FIG. 5. In a preferred embodiment, a user can click on any one of the charted symbols in a program flowchart and be transported to a screen view or window with source code corresponding to that symbol. Symbols in the applications process flowchart correspond to entire programs, files, reports, screens, etc.

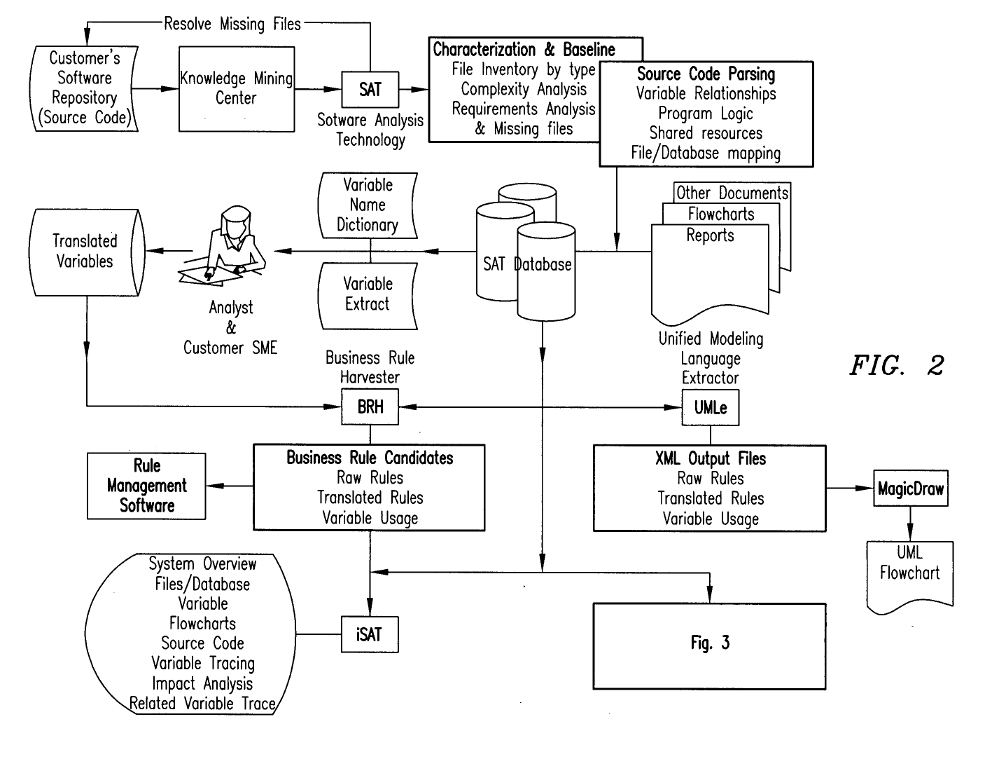

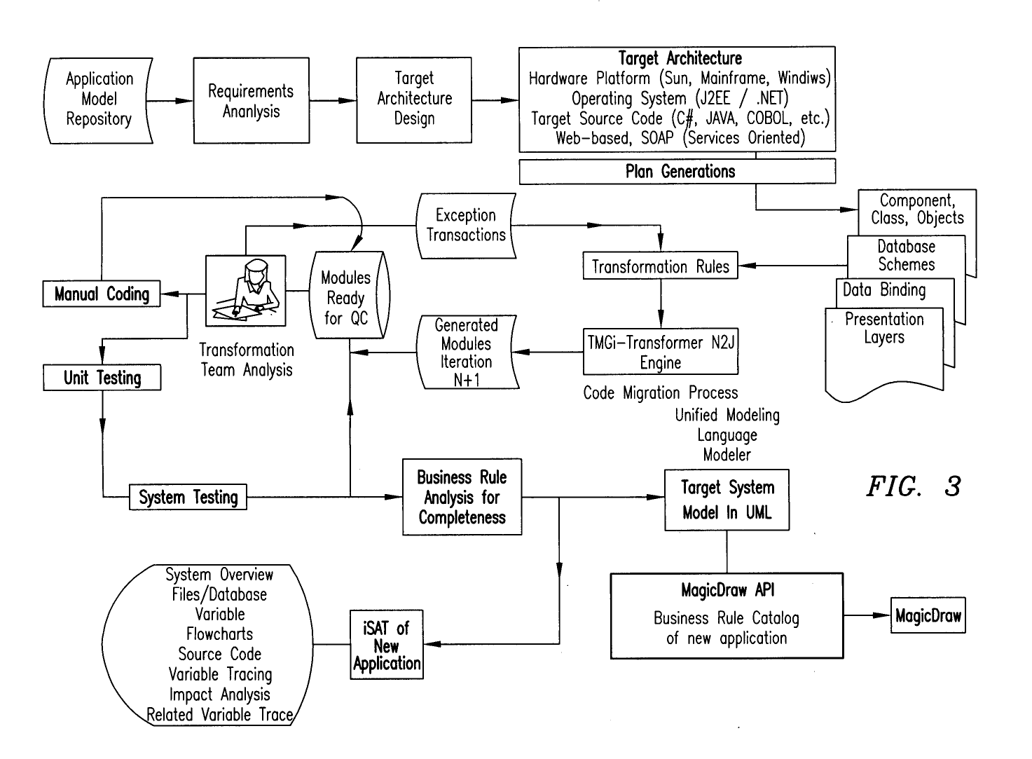

FIG. 2 and FIG. 3 show the portfolio modernization process in flowchart format. As seen in FIGS. 2 and 3, software analysis technology can be utilized to characterize and prepare a baseline for the legacy software application. Detailed knowledge mining is undertaken to prepare a database of variable relationships, program logic, shared resources and file/database mapping. A business rule harvester can be utilized to identify business rules for the application, including raw rules, translated rules and variable usage. A unified modeling language extractor can be utilized to create UML flowcharts; in a preferred embodiment, this is accomplished with the MagicDraw program.

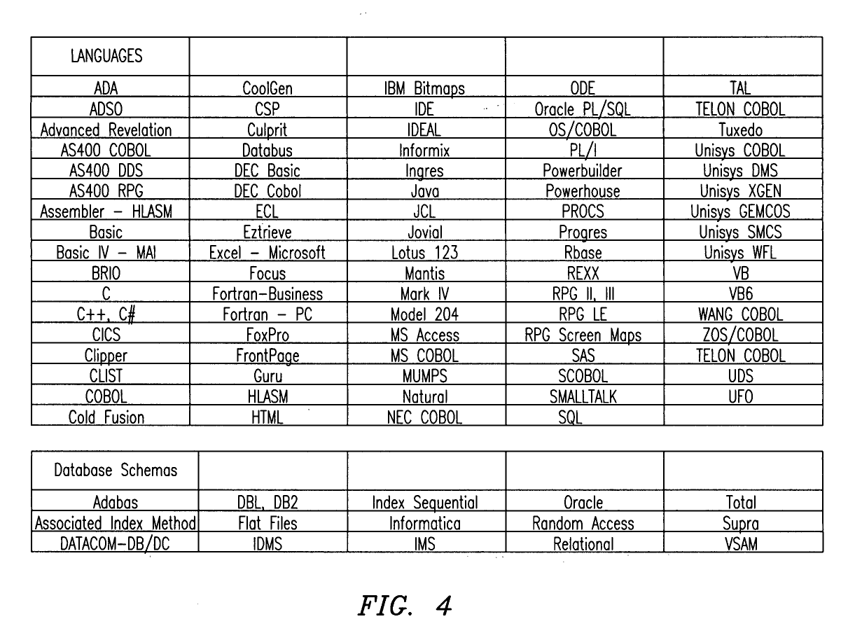

The present invention may be utilized with any number of different computer languages and database schemas, and is agnostic in that way. FIG. 4 lists exemplary languages and database schemas with which the present invention could be used, though persons of skill in the under will appreciate its applicability to other languages and database schemas.

Task 4 is “business rule harvesting,” which entails capturing and extracting the business rule buried in the legacy application code, and provides the ability to generate business models of the legacy application system. Models are created and used for understanding. To achieve that, the practitioner of the present invention can automatically capture the essential characteristics of the business functions embedded within the legacy application code. The main goal of task 4 is to capture the essence of what a program is doing and why it was written in the first place, rather than simply capturing how the program performs a set of instructions.

In performing business rule harvesting, the variables identified during the source code parsing are translated into more human-understandable terms. This is accomplished via a glossary, which is often industry specific, which corresponds usage for variable names to common usage. For example, the variable STRPOS may be translated to “string position.” The variable “CKDD” may be translated to “check date day.” Programs may also be “translated” in this way, with a table allowing program names to be conveniently correlated to program descriptors, so that program flow charts and business rules may be more readily understood. The benefit here is that the variable translation step within this Task re-standardizes the business rules to the client's industry terminology. The automatic technology tool to accomplish this step is the TMGi-VTS (variable translation system). These translations are the initial input into the building of phrases in the english format that are further processed to build full sentences.

Business rule harvesting requires loading the project, selecting the languages for which the process is to be run, and identifying the programs from which business rules will be harvested. Business variables (i.e., business-specific variables) and system variables (e.g., relating to upkeep of OS and hardware) are differentiated, ambiguities being resolved in classification as a business variables. Business rules are harvested using the TMGi-BRH (business rule harvester) automatic technology tool.

A sample of a harvested business rule is shown in Table 1.1, including the program from which the rule originated and the line from which it came. A further example is shown in FIG. 4. A business rule manager, such as those commercially available from Corticon and RulesPower, can be used for the management and organization of the business rules. Business rules can also be loaded into a business rule engine, as is familiar to a person of ordinary skill in the art.

TABLE 1.1
Sample Harvested Business Rules

| | Line | |
|---|---|---|
| Program | # | Translated Rule |
| IGMTINV01 | 92 | Inventory Sales Price Is Computed As |
| | | Inventory Purchase Order Cost Multiplied By |
| | | Inventory Markup Percent When Inventory |
| | | Purchase Order Cost Is Less Than 500.00 |
| IGMTINV01 | 95 | Inventory Cat Is Equal To 86 When Inventory |
| | | Purchase Order Cost Is More Than 500.00 And |
| | | Inventory Purchase Order Cost Is Less Than |
| | | 1000.00 |
| IGMTINV01 | 97 | Inventory Markup Percent Is Computed As 1.40 |
| | | When Inventory Purchase Order Cost Is More |
| | | Than 500.00 And Inventory Purchase Order Cost |
| | | Is Less Than 1000.00 |
| IGMTINV01 | 97 | Inventory Sales Price Is Computed As |
| | | Inventory Purchase Order Cost Multiplied By |
| | | Inventory Markup Percent When Inventory |
| | | Purchase Order Cost Is More Than 500.00 And |
| | | Inventory Purchase Order Cost Is Less Than |
| | | 1000.00 |
| IGMTINV01 | 100 | Inventory Cat Is Equal To 87 When Inventory |
| | | Purchase Order Cost Is More Than 1000.00 And |
| | | Inventory Purchase Order Cost Is Less Than |
| | | 5000.00 |
| IGMTINV01 | 102 | Inventory Markup Percent Is Computed As 1.50 |
| | | When Inventory Purchase Order Cost Is More |
| | | Than 1000.00 And Inventory Purchase Order |
| | | Cost Is Less Than 5000.00 |
| IGMTINV01 | 102 | Inventory Sales Price Is Computed As |
| | | Inventory Purchase Order Cost Multiplied By |
| | | Inventory Markup Percent When Inventory |
| | | Purchase Order Cost Is More Than 1000.00 And |
| | | Inventory Purchase Order Cost Is Less Than |
| | | 5000.00 |
| IGMTINV01 | 105 | Inventory Cat Is Equal To 90 When Inventory |
| | | Purchase Order Cost Is More Than 5000.00 |
| IGMTINV01 | 107 | Inventory Markup Percent Is Computed As 1.60 |
| | | When Inventory Purchase Order Cost Is More |
| | | Than 5000.00 |
| IGMTINV01 | 107 | Inventory Sales Price Is Computed As |
| | | Inventory Purchase Order Cost Multiplied By |
| | | Inventory Markup Percent When Inventory |
| | | Purchase Order Cost Is More Than 5000.00 |
| IGMTINV01 | 111 | End Of File Switch Is Equal To 1 |
| IGMTPUR01 | 58 | End Of File Switch Is Equal To 1 Apply |
| | | VALIDATE-PUR-MASTER Until End Of File |
| | | Switch Is Equal To 1 |
| IGMTPUR01 | 60 | 1 Is Added To Error Counter When Purchase |
| | | Order Vendor Number Is Equal To Spaces Or |
| | | Purchase Order Vendor Number Is Equal To 0 |
| IGMTPUR01 | 60 | Error Message Is Equal To ‘VENDOR |
| | | NUMBER MAY NOT BE NULL’ When |
| | | Purchase Order Vendor Number Is Equal To |
| | | Spaces Or Purchase Order Vendor Number Is |
| | | Equal To 0 |
| IGMTPUR01 | 73 | Working Area For Quantity Due Is Computed As |
| | | PUR-ORD-QTY Minus PUR-REC-QTY Plus |
| | | Purchase Order Quantity Returned To Vendor |
| | | When Purchase Order Status Is Equal To ‘O’ |
| IGMTPUR01 | 75 | 1 Is Added To Error Counter When Working |
| | | Area For Quantity Due Is Equal To 0 |
| IGMTPUR01 | 75 | Error Message Is Equal To ‘OPEN ORDER |
| | | HAS ZERO BALANCE DUE’ When Working |
| | | Area For Quantity Due Is Equal To 0 |
| IGMTPUR01 | 81 | Working Area For Quantity Due Is Computed |
| | | As PUR-ORD-QTY Minus PUR-REC-QTY Plus |
| | | Purchase Order Quantity Returned To Vendor |
| | | When Purchase Order Status Is Equal To ‘C’ |

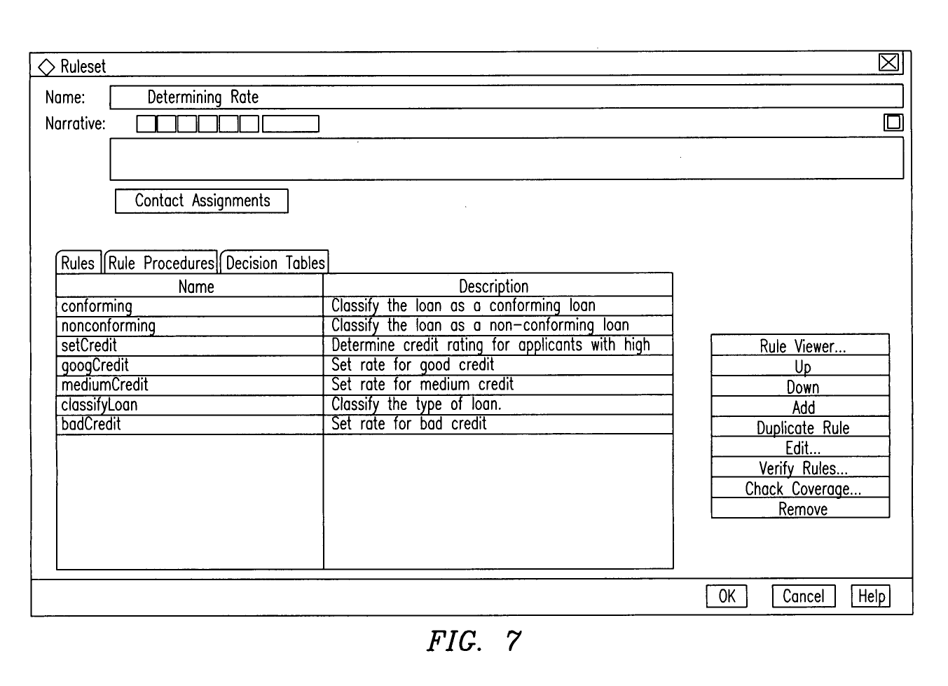

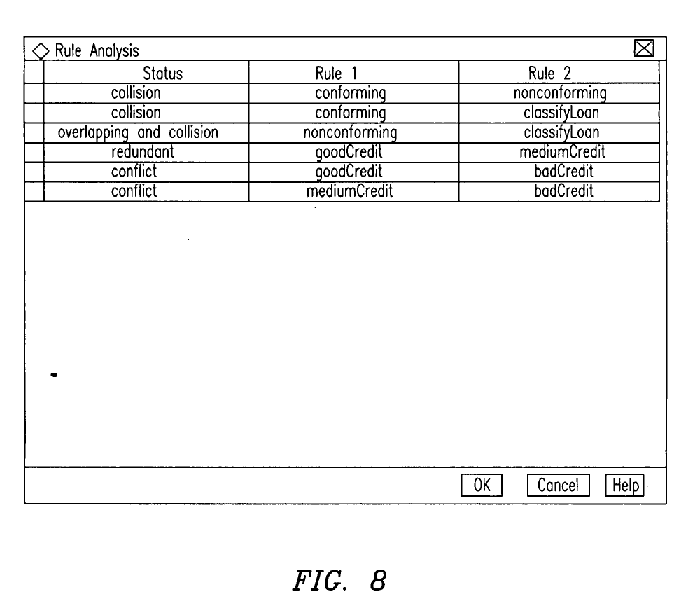

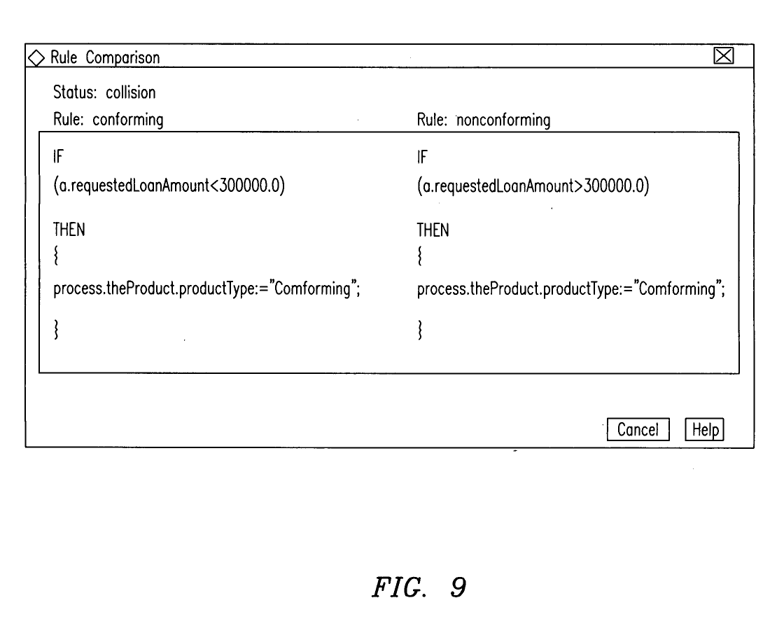

As discussed above, a common business-rules standard can be used to automatically export the business rules, business objects, and workflows into a business rules modeler, e.g., the RulesPower Business Logic Modeler. Business analysts can analyze, rationalize, and create a working prototype to validate business level functionality with historic data. A sample of the rule set is shown as FIG. 7. A sample of the rule analysis is shown as FIG. 8. A sample of the rule comparison is shown as FIG. 9.

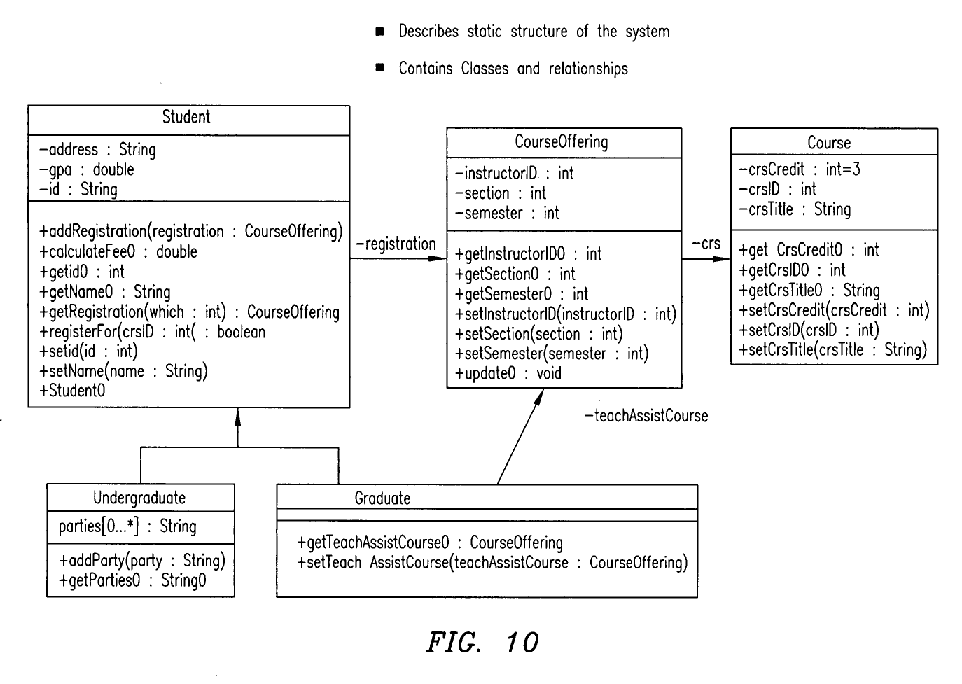

In a preferred embodiment, task 5 comprises the capture and exportation of the relevant information from the legacy application system and importing into several of the Unified Modeling Language models such as Class, Object, and Component diagrams using, by way of example, MagicDraw® by No Magic, Inc. MagicDraw is a visual UML modeling and CASE tool designed for the Business Analyst, Software Analyst, Programmer, QA Engineer, Documentation Writer, or Corporate Executive. The tool allows the developer or business professional to draw, design, and view UML diagrams of Object Oriented (OO) systems. Besides UML diagramming it also provides industry's best code engineering mechanism-full round-trip support for Java, C++, and CORBA IDL programming languages. An exemplary UML representation is shown in FIG. 10. UML models can be used to develop robust solutions and assist in understanding complex code. These tool are suited for a wide variety of systems including real-time, client/server and distributed n-tier application design. The UML representation of the captured information, though valuable, is not always necessitated to complete a conversion.

There are a total of 9 standard Unified Modeling Language (UML) diagrams that are standard and have been accepted by the Object Management Group (OMG). These are set forth in Version 2 of the UML Standard available from OMG, which is incorporated herein by reference in its entirety.

The practitioner of the present invention's knowledge mining process will extract out the pertinent information to populate, for example, a static structure UML diagram from the legacy applications data structures such as the following:

The practitioner of the present invention submits the business rules and processes that are extracted. EPM is aimed at coordinating business rules from the business perspective, and is independent of particular implementation environments. EPM harnesses the power of your business rules, documents your business rules, manages your business rules, tests your business rules for accuracy and completeness, and deploys your business rules to an execution environment using a “one click deploy” technique.

The results of all the knowledge mining processes from tasks 1 through 5, described above, may be delivered to a browser. In a preferred embodiment, the browser is a repository browser, such as Interactive Software Analysis Technology or iSAT™. This technology may be installed at the physical site of the enterprise application. Using the browser, substantially all of the information accumulated above and modeling may be presented in a readily accessible format, including, e.g., a business rules report and search capability. iSAT provides the user the ability to view the total legacy application in model or content form from a centralized repository. The benefits are the ability to view ‘impact analysis’ and variable/term traceability throughout a total application or a group of applications within the same system. The ability to view impact analysis decreasing test time and increases quality assurance.

Task 6 comprises the process of collecting the client's requirements by interviewing the client's management, subject matter experts and identified end-users (knowledge engineering). The purpose of the requirements analysis is to translate the set of software owner's views of the enterprise to a single, comprehensive architectural target for that enterprise (e.g., operating system, programming language and hardware platform).

Task 7 comprises the process of development of transformation plans. Transformation plans address the methodology for transformation to a given standard. This analysis is performed in order to generate a set of requirements needed to bridge where the application system functionality is today and where it needs to be tomorrow. The activity of generating this information is a process that involves both the knowledge mining output and the results of the requirements analysis information that were collected from knowledge engineering.

Task 8 involves re-engineering the legacy application into the target Is application. This involves the review and analysis of the actual results of all the previous tasks (1-7) into a model-driven architecture that provides the input to populating a transformation rules template for transforming the legacy application system into a target system of a different language, hardware platform or operating system. This task initializes the process of actually transforming the legacy application system into the newly elected target system such as, e.g., Natural/ADABAS to COBOL , Cobol to J2EE or NET, CoolGen to Java or Assembler to C++ or into a NET environment.

In a preferred embodiment, the automated transformer, utilizing the iSAT repository, identifies physical location of programs to be converted; standardizes source code; flags each line based upon its content or instruction type; makes initial conversion to a target language; formats and sorts, putting things in a proper sequence; analyzes operating specific-changes and includes requisite operating instructions; and creates an output of the source.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for analyzing and converting a legacy software application comprising one or more programs having source code, the method comprising:
generating a baseline inventory of said software application;
parsing said source code of said software application;
generating a set of business process models;
harvesting a set of business rules from said business process models;
identifying a set of modernization requirements;
preparing a transformation plan; and
converting said software application into a target application meeting said set of modernization requirements.

2. The method for analyzing and converting a legacy software application of claim 1, further comprising preparing an overview characterization of said software application.

3. The method for analyzing and converting a legacy software application of claim 1, further comprising generating a function point analysis.

4. The method for analyzing and converting a legacy software application of claim 1, wherein said business rule harvesting comprises differentiating business variables from system variables.

5. The method for analyzing and converting a legacy software application of claim 1, wherein said business process models comprise flowcharts for each of said programs.

6. The method for analyzing and converting a legacy software application of claim 1, further comprising generating a plurality of UML models.

7. The method for analyzing and converting a legacy software application of claim 1, further comprising using a business rules manager to manage said set of business rules.

8. A system for analyzing and converting a legacy software application comprising one or more programs having source code, said system comprising:
a computer system having storage, a memory, a display, and an input device;
software for parsing the source code of said legacy software application;
software for generating business process models;
software for automatically identifying business rules from said business process models;
software for automatically generating a plurality of UML models from said business rules; and
software for converting said legacy software application into a target application meeting a set of modernization requirements.

9. The system of claim 8, further comprising software for preparing an overview characterization of said software application.

10. The system of claim 8, further comprising software for generating a function point analysis.

11. The system of claim 8, wherein said software for identifying business rules differentiates business variables from system variables.

12. The system of claim 8, wherein said business process models comprise flowcharts for each of said programs.

13. The system of claim 8, further comprising software for generating a plurality of UML models.

14. The system of claim 8, further comprising software for managing said set of business rules.
